(19) United States
(12) Patent Application Publication
(10) Pub. No.: US 2016/0369940 A1
(43) Pub. Date: Dec. 22, 2016

(54) SENSOR MOUNTING TABLE FOR AFTERTREATMENT SYSTEMS

(71) Applicant: Cummins Emission Solutions Inc., Columbus, IN (US)

(72) Inventors: Mrinmayi Patil, Pune (IN); Amar A. Mali, Pune (IN); Maitri Chaturvedi, Pune (IN); Vinay Dandin, Madison, WI (US)

(73) Assignee: Cummins Emission Solutions Inc., Columbus, IN (US)

(21) Appl. No.: 14/743,685

(22) Filed: Jun. 18, 2015

(51) Int. Cl. F16M 13/02; F01N 3/20; F01N 3/021

(52) U.S. Cl. CPC F16M 13/02; F01N 3/021; F01N 3/2066

(57) ABSTRACT

An aftertreatment system comprises a housing including a sidewall and defining an internal volume. The housing is sized and configured to house at least one aftertreatment component within the internal volume. A sensor mounting table is coupled to the sidewall. The sensor mounting table includes a base and a plurality of legs extending from the base. Each leg of the plurality of legs includes a first portion and a second portion. The first portion extends orthogonally from the base towards the housing. The second portion extends outwardly relative to the base at a non-zero angle from an end of the first portion located distal from the base. The second portion is coupled to the sidewall of the housing, thereby coupling the sensor mounting table to the housing. At least one electronic module is removably coupled to the sensor mounting table.

### TECHNICAL FIELD

The present disclosure relates generally to aftertreatment systems for use with internal combustion (IC) engines.

### BACKGROUND

Exhaust aftertreatment systems are used to receive and treat exhaust gas generated by engines such as IC engines. Conventional exhaust gas aftertreatment systems include any of several different components to reduce the levels of harmful exhaust emissions present in exhaust gas. For example, certain exhaust aftertreatment systems for diesel-powered IC engines include a selective catalytic reduction (SCR) catalyst to convert NOx (NO and NO₂ in some fraction) into harmless nitrogen gas (N₂) and water vapor (H₂O) in the presence of ammonia (NH₃). Conventional aftertreatment systems generally include a plurality of electronic modules such as sensing modules or controllers mounted on a housing of the aftertreatment system within which the SCR system and other components of the aftertreatment system can be exposed. The electronic modules are operably coupled to interpret signals from one or more sensors included in the aftertreatment system to determine one or more parameters of the exhaust gas flowing through the aftertreatment system such as NOx concentration, particulate matter concentration, temperature, pressure, carbon monoxide levels, hydrocarbon levels, ammonia levels, etc. Installing the electronic modules on the aftertreatment system is subject to space considerations. Particularly in vertically mounted aftertreatment systems, limited space is available for safely and securely mounting the electronic modules on the aftertreatment system.

### SUMMARY

Embodiments described herein relate generally to devices and methods for mounting electronic modules on an aftertreatment system, and in particular to a sensor mounting table configured to be coupled to a housing of the aftertreatment system and structured to mount one or more electronic modules thereon to install the electronic modules on the aftertreatment system.

In a first set of embodiments, an aftertreatment system comprises a housing including a sidewall and defining an internal volume. The housing is sized and configured to house at least one aftertreatment component within the internal volume. A sensor mounting table is coupled to the sidewall. The sensor mounting table includes a base and a plurality of legs extending from the base. Each leg of the plurality of legs includes a first portion and a second portion. The first portion extends orthogonally from the base towards the housing. The second portion extends outwardly relative to the base at a non-zero angle from an end of the first portion located distal from the base. The second portion is coupled to the sidewall of the housing, thereby coupling the sensor mounting table to the housing. At least one electronic module is removably coupled to the sensor mounting table.

In another set of embodiments, a sensor mounting table for use in coupling a plurality of sensors to a housing of a vertically mounted aftertreatment system comprises a base and a plurality of legs extending from the base. Each leg of the plurality of legs includes a first portion and a second portion. The first portion extends orthogonally from the base towards the housing. The second portion extends outwardly relative to the base at a non-zero angle from an end of the first portion located distal from the base.

In yet another set of embodiments, a method of installing electronic modules on the housing of an aftertreatment system comprises providing a sensor mounting table. The sensor mounting table includes a base and a plurality of legs extending from the base. Each leg of the plurality of legs includes a first portion and a second portion. The first portion extends orthogonally from the base. The second portion extends outwardly relative to the base at a non-zero angle from an end of the first portion located distal from the base. The second portion of each leg of the plurality of legs defines a slot. At least one electronic module is coupled to the base of the sensor mounting table. The sensor mounting table is placed on a housing of the aftertreatment system such that each second portion of the plurality of legs contacts a surface of a sidewall of the housing. A fastener is inserted through each of the slots and the sidewall of the housing. The sensor mounting table is secured to the housing via the fasteners. The at least one electronic module is electronically coupled to one or more electronic components included in the aftertreatment system.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of a side view of an aftertreatment system including a sensor mounting table coupled to a housing of the aftertreatment system, and an electronic module mounted on the sensor mounting table, according to an embodiment.

FIG. 2 is a schematic illustration of a front view of the aftertreatment system of FIG. 1.

FIG. 3 is a perspective view of another embodiment of a sensor mounting table.

FIG. 4 is a side view of a portion of the sensor mounting table of FIG. 3 shown by the line A in FIG. 3.

FIG. 5 is a top view of the sensor mounting table of FIG. 3.

FIG. 6 is a top view of the sensor mounting table of FIG. 3 with a plurality of electronic modules mounted thereon.

FIG. 7 is a schematic flow diagram of a method of installing electronic modules on the housing of an aftertreatment system.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to devices and methods for mounting electronic modules on an aftertreatment system, and in particular to a sensor mounting table configured to be coupled to a housing of the aftertreatment system and structured to mount one or more electronic modules thereon to install the electronic modules on the aftertreatment system.

Embodiments of the sensor mounting table described herein provide several benefits including, for example: (1) allowing mounting of a plurality of electronic modules (e.g., sensing modules) on the housing of an aftertreatment system avoiding part proliferation and saving installation time; (2) providing compact mounting and reducing space occupied by the sensing modules on the aftertreatment system; (3) having mounting legs that include an angled portion to allow mounting on contoured surfaces (e.g., an aftertreatment system housing having a circular, oval or elliptical cross-section); (4) providing clearance or otherwise space between the housing and the electronic modules thereby protecting the electronic modules from the heat dissipated by the aftertreatment system; (5) allowing positioning of a mounting component, such as a clamp, in the space for mounting the aftertreatment system on a structure; and (6) allowing the bolting of sensor mounting table to the housing, thereby providing rigid support to protect the electronic modules from external vibrations.

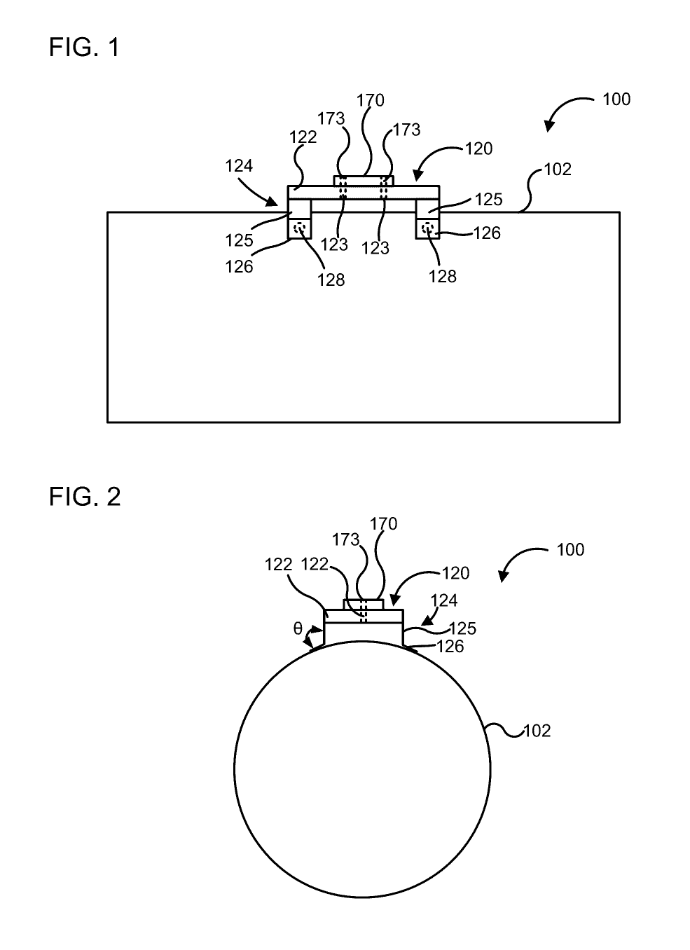

FIG. 1 s a schematic illustration of a side view of an aftertreatment system 100, according to an embodiment. FIG. 2 is a front view of the aftertreatment system 100. The aftertreatment system 100 includes a housing 102 and a sensor mounting table 120 coupled to the housing 102. The aftertreatment system 100 can be configured to treat an exhaust gas (e.g., a diesel exhaust gas) generated by an IC engine (e.g., a diesel IC engine).

The housing 102 includes a sidewall and defines an internal volume. The housing 102 is sized and configured to house at least one aftertreatment component within the internal volume. Such aftertreatment components can include, without limitation an SCR system, an oxidation catalyst (e.g., a diesel oxidation catalyst or an ammonia oxidation catalyst), a particulate filter (e.g., a diesel particulate filter, selective catalytic reduction filter), and/or a mixer such as a flow mixer. The aftertreatment components can be configured to receive the exhaust gas and decompose constituents of the exhaust gas (e.g., NOx gases, carbon monoxide, unburnt hydrocarbons and/or ammonia gas) as well as filter particulate matter (e.g., soot) from the exhaust gas.

At least a portion of the surface of the sidewall of the housing 102 is contoured. For example, as shown in FIG. 2, the housing 102 defines a circular cross-section. In other embodiments, the housing 102 can have an elliptical cross-section, or a portion of the housing 102 can define a circular or an elliptical cross-section. The housing 102 is configured to be mounted on a structure, for example a vehicle chassis. In particular embodiments, the housing 102 (and thereby the aftertreatment system) 100 is configured to be vertically mounted on the structure. For example, the aftertreatment system 100 can include a vertically mounted aftertreatment system included in tractor trailers, trucks, buses, industrial excavators and movers (e.g., bulldozers, cranes, ploughs, etc.).

The sensor mounting table 120 is coupled to the sidewall of the housing 102, for example mounted or installed on the sidewall as described herein. The sensor mounting table 120 includes a base 122 which can be flat or otherwise substantially flat. As described herein, the term “substantially flat” is understood to mean that the surface can include a certain amount of de minimus features such as contours, bumps, ridges, undulations that are commonly associated with imperfections in the manufacturing process of such flat surfaces, as would be understood by a person of ordinary skill in the art, or any other features deliberately formed on the surface as described herein.

The aftertreatment system 100 also includes an electronic module 170 which is coupled to the sensor mounting table 120. For example, as shown in FIGS. 1 and 2, a plurality of through-holes 123 are defined on the base 122. The plurality of through-holes 123 can be located to align with mating openings 173 defined in a housing of the electronic module 170 so that the electronic module 170 can be coupled to the base 122 via fasteners (not shown) inserted through the through-holes 123 and the openings 173. The fasteners can includes screws, nuts, bolts, washers or any other suitable fasteners for removably mounting the electronic module 170 on the base 122 of the sensor mounting table 120.

In particular embodiments, a plurality of protrusions (e.g., the protrusions 125 described with respect to the sensor mounting table 220) can be defined on the base 122 such that the through-holes 123 are defined within the protrusions. The protrusions can extend from the base 122 in a direction away from the housing 102. The protrusions can be configured to provide a structural rigidity to the through-holes 123 as well as provide a clearance between the base 122 and the electronic module 170 mounted thereon. The clearance can, for example, facilitate mounting of the electronic module 170 on the base 122 and/or allow air flow around the electronic module 170 to promote heat dissipation.

A variety of types of electronic modules 170 can be mounted on the base 122. The electronic modules 170 can include, for example a pressure sensing module, a temperature sensing module, a gas sensing module, particulate matter (PM) sensing module and/or any other controller. In such implementations, the number of through-holes defined through the base 122 can be varied to correspond with the openings included in each of the electronic module 170 for mounting each electronic module 170 on the base 122 as described herein.

In other embodiments, a plurality of ribs (e.g., the ribs 229 included in the sensor mounting table 220 described herein) are positioned on the base 122. The ribs can be fixedly coupled to the base 122 (e.g., welded) or monolithically defined in the base 122 (e.g., via stamping). The ribs can be configured to provide structural strength to the base 122 to increase rigidity and limit vibration communication through the base 122 to the electronic module 170 mounted thereon. In still other embodiments, the sensor mounting table 120 can also include one or more flaps (e.g., the flap 231 included in the sensor mounting table 220 described herein) extending orthogonally away from the base 122 towards the housing 102. At least one aperture can be defined in the one or more flaps. The one or more flaps can serve as alignment features, configured to be coupled to mating features defined on the housing 102 and/or mating features defined on at least one of the electronic modules 170 mounted on the base 122 to provide additional securing.

The sensor mounting table 120 also includes a plurality of legs 124 extending from the base 122. Each leg 124 of the plurality of legs 124 includes a first portion 125 and a second portion 126. The first portion 125 extends orthogonally from the base 122 (e.g., at an angle in the range of 75 degrees to 105 degrees, 80 degrees to 100 degrees, 85 degrees to 95 degrees or 87 degrees to 93 degrees inclusive of all ranges and values therebetween) towards the housing 102. The second portion 126 extends outwardly relative to the base 122 at a non-zero angle θ from an end of the first portion 125 located distal from the base 122. In other words, the second portion 126 bends away from the first portion 125 such that the second portion 126 defines the angle θ relative to the base 122.

The angle θ can be in the range of 100 degrees to 130 degrees, for example, 105 to 125 degrees or 110 to 120 degrees inclusive of all range and values therebetween. In one embodiment, the angle θ can be 118 degrees. The second portion 126 of each leg 124 of the plurality of legs 124 is positioned on the sidewall of the housing 102 and coupled to the sidewall of the housing 102 as described herein to couple the sensor mounting table 120 to the housing 102.

The angle θ of each leg 124 of the plurality of legs 124 is defined such that at least a portion of the second portion 126 is oriented tangentially to the surface of the sidewall of the housing 102. Furthermore, the first portion 125 and/or the second portion 126 can have sufficient flexibility to allow the at least a portion of the second portion 126 to be oriented tangentially to the surface of the sidewall of the housing 102 (e.g., by applying a downward force on the base 122 towards the housing 102 once the sensor mounting table 120 is positioned on the housing 102). In particular embodiments, a reinforcing rib (not shown) can be positioned between the first portion 125 and the second portion 126 of each leg of the plurality of legs 124. The reinforcing rib can provide structural strength to end of the first portion 125 to prevent or severely inhibit bending of the second portion 126 relative to the first portion 125, for example to maintain the angle θ between the first portion 125 and the second portion 126.

A slot 128 can be defined in the second portion 126 of each leg 124 of the plurality of legs 124. A fastener (not shown) is inserted through each respective slot 128 so as to couple the second portion 126 to the housing 102, thereby installing the sensor mounting table 120 on the housing 102. For example, mating openings (not shown) can be defined in the sidewall of the housing 102 for receiving the fasteners therethrough. In various embodiments, the slot 128 is rectilinear and is configured to allow the second portion 126 to slide relative to the housing 102 after the fastener is inserted through the slot 128. The rectilinear slots can allow sufficient margin or tolerance in positioning the second portion 126 of each leg 124 of the plurality of legs 124 on the sidewall of the housing 102 to facilitate coupling of the sensor mounting table 120 to the housing 102.

Thus, the sensor mounting table 120 allows mounting of one or more electronic module 170 on the housing 102 of the aftertreatment system 100 in a compact assembly which can be mounted rapidly reducing installation time and costs. The sensor mounting table 120 can reduce the space occupied by the one or more electronic modules 170 on the housing 102, as well as provide rigid support to protect the electronic modules from external vibrations. This is particularly beneficial in implementations in which the housing 102 of the aftertreatment system 100 is vertically mounted on a structure (e.g., a chassis of a vehicle such as a truck, a tractor trailer, a bus, an industrial mover etc.). The angled second portion allows mounting of the sensor mounting table 120 on contoured surfaces such as the circular cross-section of the housing 102.

Furthermore, as seen in FIGS. 1 and 2, a space exists between the base 122 of the sensor mounting table 120 and the housing 102. The space allows air flow between the housing 102 and the base 122 while limiting heat conduction between the housing 102 (which can be at a high temperature due to hot exhaust gases flowing therethrough) and the one or more electronic modules 170, thereby protecting the electronic modules 170. Moreover clamps or any other mounting component can be positioned in the space for mounting the aftertreatment system 100 on a structure, such as the chassis of vehicle.

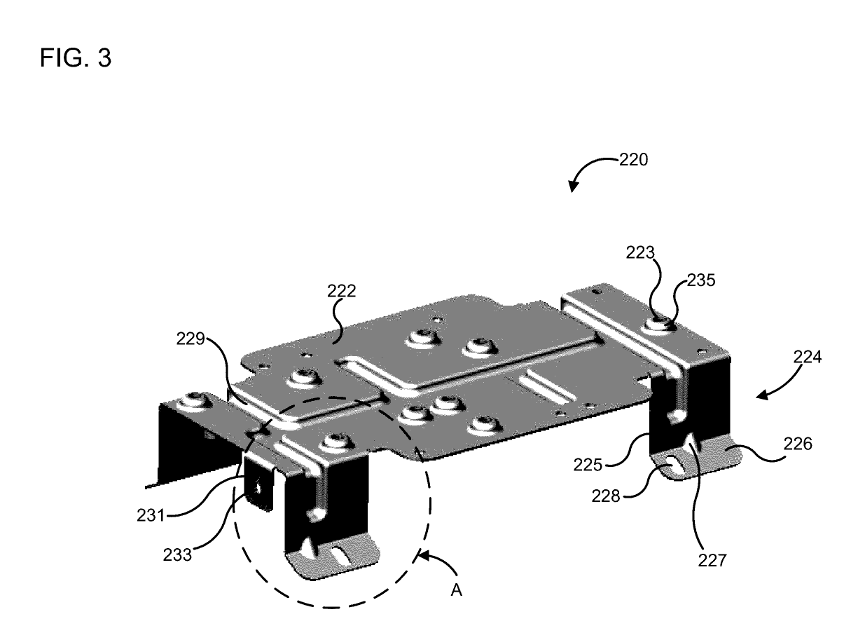

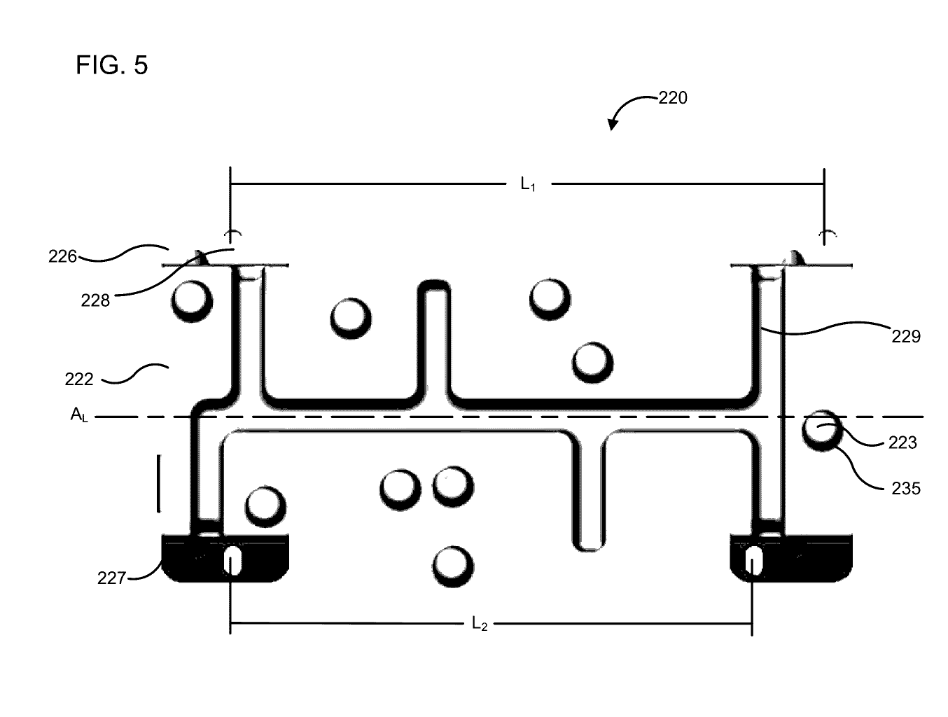

FIGS. 3-6 show another embodiment of a sensor mounting table 220. The sensor mounting table 220 is configured to mount a first electronic module 270a, a second electronic module 270b, a third electronic module 270c and a fourth electronic module 270d (collectively referred to herein as “the electronic modules 270a-d”) thereon. Furthermore, the sensor mounting table 220 is configured to be coupled to housing of an aftertreatment system (e.g., the housing 102 of the aftertreatment system 100) to install the electronic modules 270a-d on the housing of the aftertreatment system.

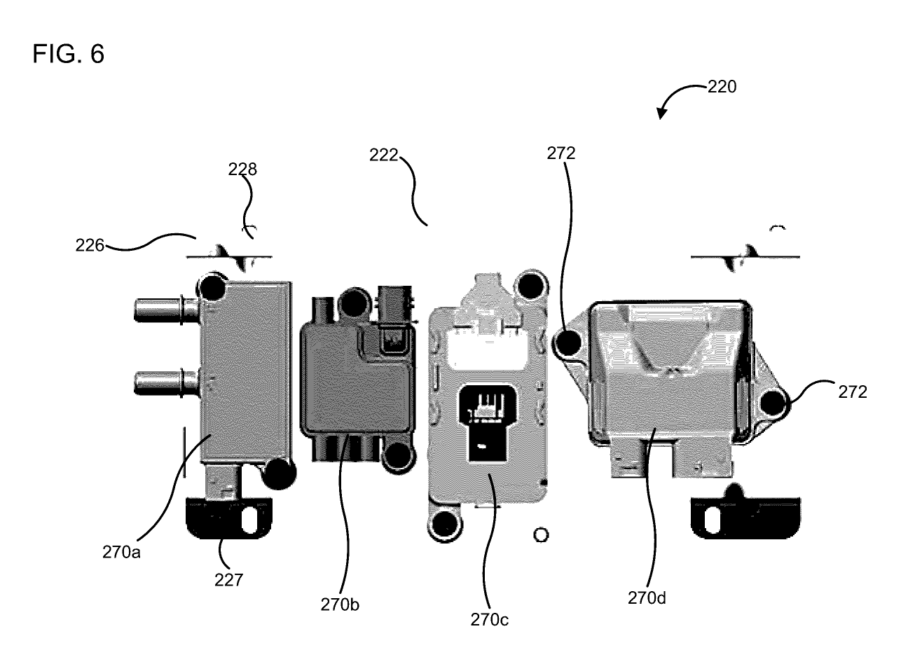

The sensor mounting table 220 includes a base 222 which can be flat or substantially flat. A plurality of protrusions 235 are defined on the base 222. Through-holes 223 are defined within each of the plurality of protrusions 235. The protrusions 235 and thereby the through-holes 223 are located to align with mating openings defined in a housing of each of the electronic modules 270a-d (See FIG. 6) positioned on the base 222. A plurality of fasteners 272 are inserted through the through-holes 223 and the openings defined in the housing of the electronic modules 270a-d to removably couple each of the electronic modules 270a-d to the base 222. The fasteners 272 can comprise screws, nuts, bolts, washers or any other suitable fasteners for removably mounting the plurality of electronic modules 270a-d on the base 222 of the sensor mounting table 220.

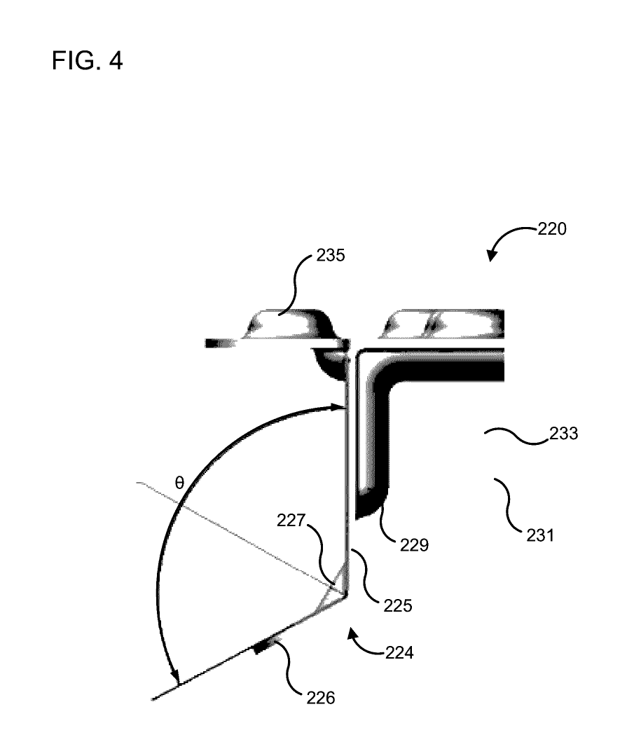

The protrusions 235 extend away from the base 222 as shown in FIGS. 3-4. The protrusions 235 can be configured to provide structural rigidity to the through-holes 223 and/or provide a clearance between the base 222 and the electronic modules 270a-d. The protrusions 235 can, for example facilitate removal from or mounting of the electronic modules 270a-d on the base 222, and/or allow air flow around the electronic module 270a-d to promote heat dissipation. The electronic modules 270a-d can include any suitable electronic modules configured to monitor one or more parameters of an aftertreatment system (e.g., the aftertreatment system 100) on which the electronic modules 270a-d are installed. For example, the first electronic module 270a may comprise a NOx sensing module, the second electronic module 270b may comprise a temperature sensing module, the third electronic module 270c may comprise a pressure sensing module and the fourth electronic module 270d may comprise a PM sensing module.

Ribs 229 are defined on the base 222 and configured to provide structural strength to the base 222. The ribs 229 can increase rigidity of the base 222 and/or limit vibration communication through the base 222 to the electronic modules 270a-d mounted thereon. The ribs 229 can be monolithically defined in the base 222, for example during a stamping operation employed to form the sensor mounting table 220. The sensor mounting table 220 also includes a flap 231 extending orthogonally away from the base 222. An aperture 233 is defined in the flap 231. The flap 231 can serve as an alignment feature, configured to be coupled to a mating feature defined on the housing (e.g., via a fastener inserted through the aperture 233) and/or a mating feature of any one of the electronic modules 270a-d to provide additional securing.

The sensor mounting table 220 includes a plurality of legs 224 extending from the base 222 in a direction shown in FIGS. 3-4. Each leg 224 of the plurality of legs 224 includes a first portion 225 and a second portion 226. The first portion 225 extends orthogonally from the base 222 (e.g., at an angle in the range of 75 degrees to 105 degrees, 80 degrees to 100 degrees, 85 degrees to 95 degrees or 87 degrees to 93 degrees inclusive of all ranges and values therebetween). The second portion 226 extends outwardly relative to the base 222 at a non-zero angle θ from an end of the first portion 225 located distal from the base 222, as shown in FIG. 4. In other words, the second portion 226 bends away from the first portion 225 such that the second portion 226 defines the angle θ relative to the base 222.

In particular embodiments, the angle θ can be in the range of 100 degrees to 130 degrees, for example, 105 to 125 degrees or 110 to 120 degrees inclusive of all range and values therebetween. In one particular embodiment, the angle θ is 118 degrees. The second portion 126 of each leg of the plurality of legs 124 is configured to be positioned and coupled to the sidewall of the housing of the aftertreatment system (e.g., the housing 102 of the aftertreatment system 100) to couple the sensor mounting table 220 to the housing. A reinforcing rib 227 is also defined at the end of the first portion 225 between a portion of the first portion 225 and a portion of the second portion 226 of each leg 224 of the plurality of legs 224. The reinforcing ribs 227 provide additional structural strength and mechanical rigidity to the second portion 226, for example to prevent bending of the second portion 226 relative to the first portion 225 and maintain the angle θ defined between the first portion 225 and the second portion 226

As described above, the second portion 226 of each leg 224 of the plurality of legs 224 is configured to be positioned on a surface of a sidewall of the housing (e.g., the housing 102). In various embodiments, at least a portion of the housing can have a curved surface. For example, the housing or at least a portion of the housing can have a circular, an elliptical or an oval cross-section. The angle θ of each leg 224 of the plurality of legs 224 is defined such that at least a portion of the second portion 126 is oriented tangentially to the surface of the sidewall of the housing (e.g., the housing 102). Furthermore, the first portion 225 can have sufficient flexibility to allow the at least a portion of the second portion 226 to be oriented tangentially to the surface of the sidewall of the housing (e.g., by applying a downward force on the base 222 towards the housing once the sensor mounting table 220 is positioned on the housing).

A slot 228 is defined in the second portion 226 of each leg 224 of the plurality of legs 224. A fastener (not shown) can be inserted through each respective slot 228 so as to couple the second portion 226 to the housing, thereby coupling the sensor mounting table 220 thereon. For example, mating openings can be defined in the sidewall of the housing for receiving the fasteners therethrough. As shown in FIGS. 3-6, each slot 228 has a rectilinear shape. The slots 228 are configured to allow the second portion 226 to slide relative to the housing after the fastener is inserted through the slot 228. The rectilinear slots can allow sufficient margin or tolerance in positioning the second portion 226 of each leg 224 of the plurality of legs 224 on the sidewall of the housing to facilitate installation.

In particular embodiments, a first pair of slots 228 positioned parallel to a longitudinal axis A_{L} of the sensor mounting table 220 and located on a first side of the sensor mounting table 220 define a first distance L₁ therebetween. Moreover, a second pair of slots 228 positioned parallel to the longitudinal axis A_{L} of the sensor mounting table 220 and located on a second side of the sensor mounting table 220 opposite the first side define a second distance L₂ therebetween such that L₁ is greater than L₂. The distances L₁ and L₂ can be varied to correspond with locations of openings defined on housings of different aftertreatment systems.

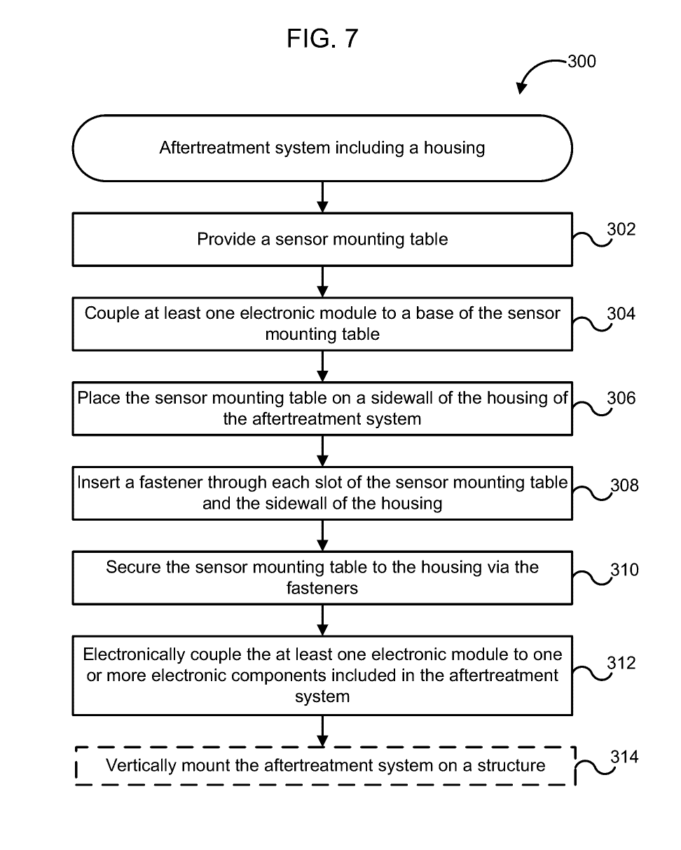

FIG. 7 is a schematic flow diagram of a method 300 outlining the process for mounting or installing at least one electronic module (e.g., the electronic module 170 or 270a-d) on the housing of an aftertreatment system (e.g., the housing 102 of the aftertreatment system 100). The method 300 includes providing a sensor mounting table at 302, for example, the sensor mounting table 120 or 220. The sensor mounting table includes a base (e.g., the base 122 or 222 as described above), and a plurality of legs extending from the base (e.g., the plurality of legs 124 or 224 as described above). The base can be substantially flat and configured to receive at least one electronic module thereon. A plurality of through-holes can be defined in the base (e.g., the through-holes 123 or 223 as described before herein) for coupling at least one electronic module thereto, as described herein.

Each leg of the plurality of legs includes a first portion and a second portion (e.g., the first portion 125 or 225, or the second portion 126 or 226 included in the plurality of legs 124 and 224, respectively). The first portion extends orthogonally from the base. The second portion extends outwardly relative to the base at a non-zero angle (e.g., in the range of 100 to 130 degrees, 105 to 125 degrees or 110 to 120 degrees inclusive of all range and values therebetween) from an end of the first portion located distal from the base. In one embodiment, the angle can be 118 degrees. The second portions of each leg of the plurality of legs define a slot, for example a rectilinear slot (e.g., the slot 228 included in the second portion 226 of each leg 224 of the plurality of legs 224 included in the sensor mounting table 220).

At least one electronic module is coupled to the base of the sensor mounting table at 304. For example, the electronic module 170 or the electronic modules 270a-d can be mounted on the base of the sensor mounting table. Fasteners can be inserted through the through-holes defined in the base (e.g., the through-holes 123 or 223 included in the sensor mounting table 120 and 220, respectively) and through corresponding openings defined in a housing of the at least one electronic module for coupling the at least one electronic module to the base.

In particular embodiments, a plurality of protrusions (e.g., the protrusions 235 included in the sensor mounting table 220) can be defined on the base such that the through-holes are defined through the protrusions. The openings of the at least one electronic module can be aligned with the through-holes defined in the protrusion. The one or more electronic modules are then mounted by inserting fasteners through the electronic module and the at least one of the through-holes.

The sensor mounting table is placed on a sidewall of the housing of the aftertreatment system at 306, such that each second portion of the plurality of legs contacts a surface of a sidewall of the housing. For example, the second portion of each leg of the plurality of legs (e.g., the second portion 226 of the plurality of legs 224) is positioned on the sidewall of the housing such that at least a portion of the second portion is oriented tangentially to a surface of the sidewall of the housing.

A fastener is inserted through each of the slots and the sidewall of the housing at 308. For example, the sensor mounting table can be placed on the sidewall of the housing such that the slots defined on the second portion of each leg of the plurality of legs align with corresponding openings defined on the sidewall of the housing. The sensor mounting table is secured to the housing via the fasteners at 310. For example, the openings defined on the sidewall of the housing can include threaded openings and the fasteners can include screws or bolts threaded into the openings.

The at least one electronic module is electronically coupled to one or more electronic components included in the aftertreatment system at 312. For example, the electronic module can include a NOx sensing module, pressure sensing module, a temperature sensing module and/or a PM sensing module. The electronic module is configured to be operably coupled to any aftertreatment component, for example sensors such as NOx sensors, pressure sensors, temperature sensors and/or PM sensors for monitoring key operational parameters of the aftertreatment system. In particular embodiments, the aftertreatment system is vertically mounted on a structure at 314, for example, vertically mounted on the chassis of a truck, a bus, a tractor-trailer, an industrial moving equipment, etc.

Any of the sensor mounting tables defined herein, for example the sensor mounting table 120 or 220 can be formed from a strong and rigid material such as metals (e.g., aluminum, stainless steel, iron, alloys, etc.), plastics, ceramics, polymers or any other suitable material. Furthermore, the sensor mounting tables described herein can be formed using any suitable manufacturing process, for example stamping, welding, casting, etc. In particular embodiments, a heat insulating material such as rubber pads, polymer pads, foam etc. can be positioned between the second portion of the plurality of legs of the sensor mounting table (e.g., the sensor mounting table 120 or 220) and the housing (e.g., the housing 102). The heat insulation material serves to limit heat transfer between the housing 102 and the sensor mounting table 120 and the electronic modules (e.g., the electronic module 170 or 270a-d)

The terms “coupled,” “connected,” and the like as used herein mean the joining of two members directly or indirectly to one another. Such joining may be stationary (e.g., permanent) or moveable (e.g., removable or releasable). Such joining may be achieved between two members or the two members and any additional intermediate members being integrally formed as a single unitary body with one another or with the two members or the two members and any additional intermediate members being attached to one another.

It is important to note that the construction and arrangement of the various embodiments presented herein are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An aftertreatment system, comprising:
a housing including a sidewall and defining an internal volume, the housing sized and configured to house at least one aftertreatment component within the internal volume;
a sensor mounting table coupled to the sidewall, the sensor table including:
a base,
a plurality of legs extending from the base, each leg of the plurality of legs including a first portion and a second portion, the first portion extending orthogonally from the base towards the housing, the second portion extending outwardly relative to the base at a non-zero angle from an end of the first portion located distal from the base, the second portion coupled to the sidewall of the housing, thereby coupling the sensor mounting table to the housing; and
at least one electronic module removably coupled to the sensor mounting table.

2. The aftertreatment system of claim 1, wherein the base is flat.

3. The aftertreatment system of claim 1, wherein the angle is in the range of 100 degrees to 130 degrees.

4. The aftertreatment system of claim 3, wherein the angle is 118 degrees.

5. The aftertreatment system of claim 1, wherein a slot is defined in the second portion of each leg of the plurality of legs, and wherein a fastener is inserted through each respective slot so as to couple the second portion to the housing.

6. The aftertreatment system of claim 5, wherein the slot is rectilinear and configured to allow the second portion to slide relative to the housing after the fastener is inserted through the slot.

7. The aftertreatment system of claim 1, wherein a plurality of through-holes are defined on the base, and wherein the at least one electronic module is coupled to the base via fasteners inserted through the through-holes.

8. The aftertreatment system of claim 7, wherein a plurality of protrusions are defined on the base, and wherein the through-holes are defined within the protrusions.

9. The aftertreatment system of claim 1, wherein a plurality of ribs are positioned on the base.

10. The aftertreatment system of claim 1, wherein the sensor table includes at least one flap extending orthogonally away from the base towards the housing, at least one aperture defined in the at least one flap.

11. The aftertreatment system of claim 1, wherein the at least one electronic module includes at least one of a pressure sensing module, a temperature sensing module, a gas sensing module, a particulate matter sensing module and a controller.

12. The aftertreatment system of claim 1, further comprising the aftertreatment component positioned within the internal volume of the housing, the aftertreatment component comprising at least one of:
a selective catalytic reduction system,
an oxidation catalyst,
particulate filter, and
a mixer.

13. A sensor mounting table for use in coupling a plurality of sensors to a housing of a vertically mounted aftertreatment system, comprising:
a base; and
a plurality of legs extending from the base, each leg of the plurality of legs including a first portion and a second portion, the first portion extending orthogonally from the base towards the housing, the second portion extending outwardly relative to the base at a non-zero angle from an end of the first portion located distal from the base.

14. The sensor mounting table of claim 13, wherein the base is flat.

15. The sensor mounting table of claim 13, wherein the angle is in the range of 100 degrees to 130 degrees.

16. The sensor mounting table of claim 13, wherein a slot is defined in the second portion of each leg of the plurality of legs, and wherein a fastener is inserted through each respective slot so as to couple the second portion to the housing.

17. The sensor mounting table of claim 16, wherein the slot is rectilinear and configured to allow the second portion to slide relative to the housing after the fastener is inserted through the slot.

18. The sensor mounting table of claim 13, wherein a plurality of through-holes are defined on the base, and wherein the at least one electronic module is coupled to the base via fasteners inserted through the through-holes.

19. The sensor mounting table of claim 18, wherein a plurality of protrusions are defined on the base, and wherein the through-holes are defined within the protrusions.

20. The sensor mounting table of claim 13, wherein a plurality of ribs are positioned on the base.

21. A method of installing at least one electronic module on the housing of an aftertreatment system, comprising:
providing a sensor mounting table including:
a base, and
a plurality of legs extending from the base, each leg of the plurality of legs including a first portion and a second portion, the first portion extending orthogonally from the base, the second portion extending outwardly relative to the base at a non-zero angle from an end of the first portion located distal from the base, the second portion of each leg of the plurality of legs defining a slot;
coupling at least one electronic module to the base of the sensor mounting table;
placing the sensor mounting table on a housing of the aftertreatment system such that each second portion of the plurality of legs contacts a surface of a sidewall of the housing;
inserting a fastener through each of the slots and the sidewall of the housing;
securing the sensor mounting table to housing via the fasteners; and
electronically coupling the at least one electronic module to at least one electronic component included in the aftertreatment system.

22. The method of claim 21, further comprising:
vertically mounting the aftertreatment system on a structure.

23. The method of claim 21, wherein the slot is rectilinear and configured to allow the second portion to slide relative to the housing after the fastener is inserted through the slot.

24. The method of claim 21, wherein the angle is in the range of 100 degrees to 130 degrees.

25. The method of claim 22, wherein a plurality of protrusions are defined on the base, a through-hole defined through each protrusion, and wherein mounting the at least one electronic module on the base includes inserting fasteners through the electronic module and the at least one of the through-holes.
